(19) United States
(12) Patent Application Publication
(10) Pub. No.: US 2006/0171377 A1
(43) Pub. Date: Aug. 3, 2006

(54) Automated remote device meter reading

(75) Inventors: Donald J. Gusmano, Henrietta, NY (US); Michael R. Furst, Rochester, NY (US); Ronald M. Rockwell, Rochester, NY (US)

Correspondence Address: Oritz & Lopez, PLLC, P.O. Box 4484, Albuquerque, NM, 87196-4484, US

(73) Assignee: Xerox Corporation

(21) Appl. No.: 11/177,608

(22) Filed: Jul. 7, 2005

Related U.S. Application Data
(60) Provisional application No. 60/650,453, filed on Feb. 3, 2005.

(51) Int. Cl. H04L 12/66

(52) U.S. Cl. 370/352; 370/241

(57) ABSTRACT

System meter reads can be sent automatically from a document rendering device to a remote server over a communications system without customer intervention. Network-based systems are enabled to automatically collect and report usage information from equipment to remote servers. Usage information is used for billing and/or maintenance purposes.

### CROSS REFERENCE TO PROVISIONAL APPLICATION

The embodiments claimed herein claim the benefit of U.S. Provisional Patent Application 60/650,453, entitled “Automated Remote Device Meter Reading”, which was filed Feb. 3, 2005.

### TECHNICAL FIELD

The embodiments generally relate to rendering device meter count information management. More particularly, the embodiments relate to the automation of meter reading by service providers of remote devices such as printers, photocopiers and fax machines located at customer/leasee operational sites.

### BACKGROUND

Meter counts are typically required under equipment leases to track usage, which is used for billing and service purposes by a leasing or servicing company (hereinafter “service provider”). Additionally, service projections for equipment can be determined by a service provider from equipment usage data reported by an equipment user/customer (hereinafter “customer”).

As shown in FIG. 1, which is labeled as prior art, meter count information 110 located in service provider equipment 100 can be read by a customer, e.g., such as use meters located in photocopiers located at a customer's place of business. The customer can provide the information to the service provider via telephone 120, fax 130, and networked computer 140 using email or Web form entries. Customers can sometimes access meter information directly from the equipment through a local user interface 105. Processes requiring human intervention are time consuming to the customer, error prone and unreliable to the service provider. Unfortunately, physical meter reading and reporting introduces a human factor that can result in errors or lack of timely reporting to the service provider.

Alternatively, some systems are automated and enable meter reading of service provider equipment through communications devices associated with the leased or serviced equipment. Such systems, however, are “pull” based and are considered invasive by customers. Such system can create customer apprehension and dissatisfaction because of unannounced remote intrusion into the customer's equipment or enterprise communications systems.

Accordingly, the present inventors have determined that it would be desirable to provide improved methods and system for obtaining leased equipment usage information. The inventors believe that equipment metering can be improved with automated readings and reporting of usage data.

### BRIEF SUMMARY OF EMBODIMENTS

It is a feature to provide improved meter reading and usage reporting processes for leased equipment.

Accordingly, it is a feature of the embodiment for a communications device associated with equipment under lease or a service contract (hereinafter “equipment”), e.g., such as a photocopier, to remotely log into a server associated with a leasing company or service provider (hereinafter “service provider”) and identify equipment to the server.

According to another feature, identification of remote equipment to a server includes at least one of: equipment serial number(s) and/or password(s).

According to another aspect, equipment is registered with a service provider's billing system when the equipment initially logs into the server.

According to another aspect of the present embodiment, the server informs an associated billing system when previously registered equipment logs in to the server or newly registered equipment has been registered by the server after log-in or registration is completed.

According to another aspect of the present embodiment, equipment can identify itself with the server by periodically polling the server.

In accordance with another aspect of the embodiments, the remote device provides usage data from at least one meter associated with customer equipment to the server, or through the server, to the billing system.

In accordance with yet another aspect of the embodiment, at least one of the billing system or the server automatically notifies the customer of newly registered equipment and identifies all equipment currently registered with the server and/or automated billing system, (e.g., all equipment including existing and newly registered equipment).

In accordance with yet another aspect of the embodiment, a customer of newly registered equipment can select which equipment are to be added to the automated meter reading system following registration, said selection occurring after registration of equipment with at least one of the billing system or the server.

In accordance with yet another aspect of the embodiment, remote equipment maintains a reporting schedule whereby remote equipment automatically communicates with the server.

In accordance with yet another aspect of the embodiment, equipment maintains a reporting schedule whereby the equipment communicates with the server automatically and downloads instructions from the server.

In accordance with yet another aspect of the embodiment, the equipment polls itself after automatically downloading instructions from the server and then passes data back to the server via communications.

Advantages of the embodiment include process validation through an entire metering chain (e.g., equipment-server-billing-system-server-equipment), cost savings to service providers and customers, and increased customer/service provider satisfaction. A service provider's equipment is non-invasive because a customer's device polls a service provider's server instead of a service provider's server freely logging into and communicating with a customer's remote equipment.

### BRIEF DESCRIPTION OF THE DRAWINGS

The accompanying figures, in which like reference numerals refer to identical or functionally-similar elements throughout the separate views and which are incorporated in and form part of the specification, further illustrate embodiments of the present invention.

FIG. 1 (labeled prior art) illustrates components of prior automated reporting systems utilized in accordance with carrying out the embodiments;

FIG. 2 illustrates components of an automated meter reading system located in metered equipment are shown;

FIG. 3 illustrates components of a system architecture supporting automated meter reporting as utilized in accordance with carrying out the embodiment; and

FIG. 4 illustrates a flow diagram of process steps in accordance with features of the embodiments.

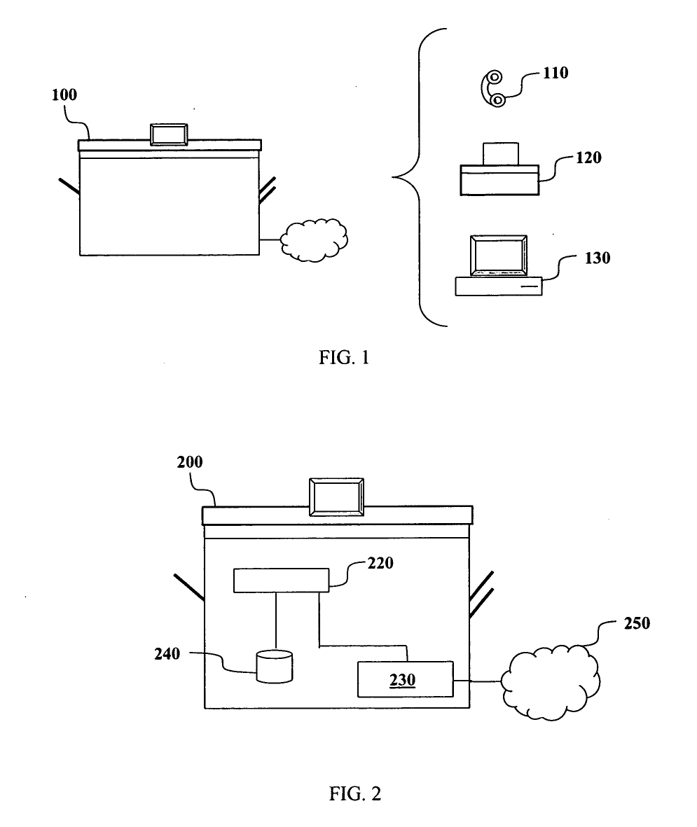

### DETAILED DESCRIPTION OF EMBODIMENTS

The particular values and configurations discussed in these non-limiting examples can be varied and are cited merely to illustrate an embodiment of the present invention and are not intended to limit the scope of the embodiments.

Referring to FIG. 2 components of an automated meter reading system 110 located in metered equipment 200 are shown. Metered equipment 100 in accordance with features of the embodiment includes an automated metering system 210 for tracking system use and reporting use to a remote server. The automated metering system includes a usage meter 220 and network communications 230. The usage meter 220 records usage of the equipment 200 by tracking, for example, the number of renderings (e.g., printout) the equipment provided during a reporting period. Communications 230 enable the conveyance of meter information to a remote server over a data communications network 250. Communications 230 can include hardware in use such as an analog modem, Ethernet, and network server and router. Communications can be over wired or wireless networks. A memory 240 can be used to store meter information, and the memory can also store registration information (e.g., password, identification) and/or system updates provided by a remote server.

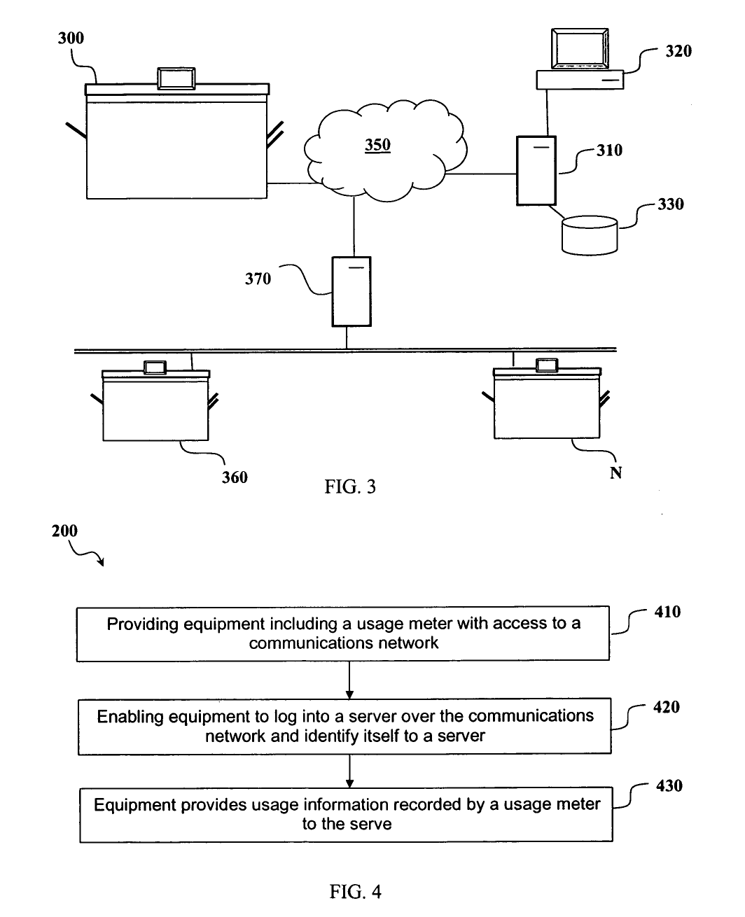

Referring to FIG. 3, system architecture 300 in support of automated equipment meter reporting is shown. Meter equipment 300 can communicated over a network 350 to a server 310 where the equipment 300 is logged into the server 310 and identified. The server 310 identifies the equipment 300 and retrieves meter information from the equipment 300. The equipment 300 is identified to a billing system 320 wherein meter information is processed for billing and/or service transactions. Information from or about the equipment can be stored in a database 330. Updates can also be retrieved from the database 330 by equipment 300 after it has logged into the server 310.

Although equipment 300 is shown with a direct connection through a network 350 to the server 310, other equipment 360 through N may utilize the support of external communications hardware 370 to communicate through the network to server 310. External communications hardware 370 can support an enterprise responsible for equipment 360 by monitoring communications, creating a record of transmitted data (e.g., metering and updates).

Referring to FIG. 4, a flow diagram 400 illustrating steps in accordance with carrying out a feature of the embodiment is shown. As shown in Step 410, equipment including a usage meter is provided with access to a communications network. In step 420 the equipment is enabled to log into a server over the communications network and identify itself to the server. As shown in Step 430, the equipment provides usage information recorded by the usage meter to the server. Identification of the equipment to the server can include at least one of: a serial number and/or a password. The equipment can log into the remote server based on a reporting schedule. The equipment can become registered with the server when the equipment initially logs into the server over the communications network. The equipment can identify itself to the remote server for a first time upon initial log in and prior to providing usage information recorded by the meter. The equipment can provide at least one of a serial number and a password to the server for its identification to the server upon initial registration. The server can be adapted to receive usage data from at least one meter associated with equipment adapted to log into the remote server via the communications network. The usage information can be provided by the server to a billing system adapted to maintain usage information in association with equipment. A billing system associated with the remote server can automatically notifies customers about equipment associated with the customers that are or become registered with the server for automated reporting. A reporting schedule can be maintained at the equipment automatically communicates with the server based on the reporting schedule. Equipment can communicate with the remote server automatically in accordance with the reporting schedule and can download reporting instructions from the server.

The methods and systems described herein can automate what is currently a very manual process in part of the customer. Automating system usage recorded by a meter saves costs and ensures accuracy.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An automated equipment usage reporting system, comprising:
a usage meter associated with remote equipment; and
communications hardware associated with said remote equipment and adapted to communicate through a network with a service provider server, log into the service provider server, identify the remote equipment to the server and transmit usage meter data to the server.

2. The system of claim 2 wherein the remote equipment is adapted to that it can identify itself to the server by periodically polling the service provider server.

3. The system of claim 2 wherein identification of said remote equipment to the service provider server includes transmission from said remote equipment of at least one of a serial number and/or password.

4. The system of claim 1 wherein the remote equipment includes at least one of a photocopier.

5. The system of claim 4 wherein the remote equipment is adapted so that it can identify itself to the server by periodically polling the service provider server.

6. The system of claim 4 wherein identification of the remote equipment to the service provider server includes transmission from the remote equipment of at least one of a serial number and/or password.

7. The system of claim 1 further comprising:
a server adapted to accept remote equipment log ins, register remote equipment, identify remote equipment, and receive usage meter information from remote equipment.

8. The system of claim 7 wherein identification of said remote equipment to the service provider server includes transmission from said remote equipment of at least one of a serial number and/or password.

9. The system of claim 7 wherein said remote equipment includes at least one of a photocopier.

10. The system of claim 7 wherein the remote equipment is adapted so that it can identify itself to the server by periodically polling the service provider server.

11. The system of claim 10 wherein said remote equipment includes at least one of a photocopier.

12. The system of claim 11 wherein said remote equipment is adapted so that it can identify itself to the server by periodically polling the service provider server.

13. The system of claim 12 wherein identification of the remote equipment to the service provider server includes transmission from the remote equipment of at least one of a serial number and/or password.

14. An automated equipment usage reporting system, comprising:
a server adapted to accept remote equipment log ins, register remote equipment, identify remote equipment, and receive usage meter information from remote equipment; and
a billing system adapted to receive usage meter information for remote equipment from the server and process the usage meter information for at least one of billing and/or service scheduling.

15. The system of claim 14 wherein identification of remote equipment to the server includes at least one of a serial number and/or password associated with the remote equipment and registered in the server.

16. The system of claim 14 wherein the server is adapted so that the remote equipment can identify itself to the server by periodically polling the server.

17. The system of claim 14 wherein the remote equipment includes photocopiers.

18. A method for providing usage meter information over a network from equipment to a server and associated billing system, comprising the steps of:
providing the equipment including a usage meter with access to a communications network;
enabling the equipment to log into a server over the communications network and identify itself to the server; and
said equipment providing usage information recorded by a usage meter to the server.

19. The method of claim 18 wherein identification of the equipment to the server includes least one of: a serial number and/or a password.

20. The method of claim 18 wherein the equipment logs into the server based on a reporting schedule.

21. The method of claim 18 wherein the equipment is registered with the server when the equipment initially logs into the server over the communications network;
the equipment identifies itself to the server for a first time upon initial log in and prior to providing the usage information recorded by the meter; and
the equipment provides at least one of a serial number and a password to the server for identification of the equipment to the server upon initial registration with the server.

22. The method of claim 21 wherein the server is adapted to receive usage data from at least one meter associated with equipment adapted to log into the remote server via the communications network.

23. The method of claim 22 wherein the usage data is provided by the server to a billing system adapted associated with the server so that the server will maintain the costs in association with the usage data associated with the equipment.

24. The method of claim 18 wherein a billing system associated with the remote server automatically notifies customers about equipment associated with the customers that are or become registered with the server for automated reporting.

25. The method of claim 18 wherein a reporting schedule is maintained as the equipment automatically communicates with the server based on the reporting schedule.

26. The method of claim 18 wherein the equipment includes a photocopier, wherein the photocopier is adapted to communicate with the server automatically in accordance with the reporting schedule and downloads reporting instructions from the server.
